(19) United States
(12) Patent Application Publication
(10) Pub. No.: US 2009/0205685 A1
(43) Pub. Date: Aug. 20, 2009

(54) Shopping Basket Washer and Sanitizer

(76) Inventor: James R. Metheny, Jefferson, GA (US)

Correspondence Address: SHOEMAKER AND MATTARE, LTD, 10 POST OFFICE ROAD - SUITE 100, SILVER SPRING, MD, 20910, US

(21) Appl. No.: 12/412,075

(22) Filed: Mar. 26, 2009

Related U.S. Application Data
(63) Continuation-in-part of application No. 12/031,563, filed on Feb. 14, 2008.
(60) Provisional application No. 61/039,939, filed on Mar. 27, 2008.
(60) Provisional application No. 60/889,841, filed on Feb. 14, 2007.
(60) Provisional application No. 60/909,204, filed on Mar. 30, 2007.

(51) Int. Cl. B08B 3/04

(52) U.S. Cl. 134/45; 134/123

(57) ABSTRACT

A shopping basket washer and sanitizer includes an enclosure fitted with components that facilitate the entry and exit of shopping baskets and related or similar items for the purpose of washing, rinsing, disinfecting and/or drying. Within the apparatus, the baskets are washed, rinsed, disinfected and dried. The apparatus is intended primarily for use inside retail establishments so as to provide a continuous supply of clean and sanitary shopping baskets to customers.

This application claims benefit of provisional application 61/039,939 filed Mar. 27, 2008, and is a continuation-in-part of copending application Ser. No. 12/031,563, filed Feb. 14, 2008, which claims benefit of provisional applications 60/889,841, filed Feb. 14, 2007, and 60/909,204, filed Mar. 30, 2007, the disclosures of which are incorporated herein by reference.

### BACKGROUND OF THE INVENTION

This invention relates to a shopping basket washer and sanitizer, more particularly to a totally self-contained high pressure hot/cold water cleaning unit for shopping baskets, hand held shopping baskets and related or similar items.

Retail businesses, including grocery, clothing, auto parts, hardware, specialty stores and more, routinely provide to the shopper plastic hand held shopping baskets and the like for the collection of intended purchases.

These baskets are subject to contamination by shoppers, especially in the retail grocery, retail hardware trade and retail automotive product trade. Contamination may result from contact with raw meats, raw fish, raw chicken, vegetables, chemicals (cleaners, paint products, dry masonry products, grease, oil and more), poisons (varmint control products, vegetation control products, insecticides, fertilizers, potting soils and more).

It is important to minimize or eliminate the potential for the spreading of germs and bacteria by of these devices, and it is just as important to eliminate the hazards introduced by human touch and those introduced by the placement of such things as chemicals and poisons into the shopping basket.

By eliminating as much contamination as possible, not only are health risks reduced, but also potential legal claims on the retailer are reduced, lowering financial risk both by direct losses and loss of productivity in defending claims and the direct expense of defending such claims.

Standard practice in the past is for the retailer to occasionally clean the shopping basket outside the store with a pressure washer or similar mobile cleaning service. The best solution and most practical approach to the prevention of the spread of contaminants, bacteria and germs is not occasional cleaning but continual cleaning and disinfecting as the shopping device rotates through daily use.

Without a pattern of continual cleaning, a shopping basket retains accumulated contamination, thereby reducing the effectiveness of any germicide which is applied.

Prior art cleaning devices attempt to improve on the manual method of cleaning by introducing automation and germicide. They fall short of addressing the need for cleaning and disinfecting the shopping baskets on an “each time used” basis (continual cleaning and disinfecting as the basket rotates through daily use by shoppers).

Prior attempts to automate basket cleaning have failed to provide easy access to automated units without the use of moving platforms, presenting a danger of injury to the user.

Prior attempts at automation have also failed to incorporate automated start and stop devices (electronic beams) and computerized cycle start, stop and timers necessary for consistent delivery of cleaner, rinse, disinfectant and the drying process.

Some prior devices have provided for the delivery of germicide; however, without continual cleaning, the efficiency of the application of the germicide is diminished.

Regular cleaning of shopping devices would decrease required maintenance required due to grit, dirt, and foreign particle that may have otherwise accumulated in moving parts (i.e., wheels, bearings, hinges, etc.), reducing costs in repairs and downtime to the retailer.

### SUMMARY OF THE INVENTION

The primary purpose of the invention is to provide a totally self contained hot/cold pressurized cleaning system for hand held shopping baskets and the like which is easy to operate, is quiet, and provides for the continuous cleaning of baskets as opposed to an occasional wash. Once baskets are moved to the entrance and “picked up” by a conveyor, the operator need only to wait until the basket exits making the unit totally automated and self contained—all in the comfort of in-store use.

This and other objectives of the invention are accomplished by a tunnel affixed to a frame having four locking wheels for temporary mobility as needed. The unit may be hard wired and/or hard plumbed, for example in a new or remodeled store, or it may be provided with an electrical cord for power and a holding tank to retain used liquids until their safe disposal.

The baskets moved through the unit by conveyor chain loops to which flights or paddles are attached. The paddles are adjustable to accommodate different sizes and styles of shopping baskets. As the basket enters a laser enabled “eye” begins the wash cycle. A computer controlled timer controls the rinse, germicide application and dry cycles. As the basket exits the unit, the controller ends the cycle.

Cleaning, rinsing and sanitizing liquids are delivered—via a pump and valves—under pressure to a series of nozzles along the interior of the unit. Used liquids are collected into the holding tank by means of a floor drain.

The present system is intended to enhance the retail customers' level of satisfaction with the shopping experience and provide peace of mind as to their safety and that of their family and friends.

An optional feature the provision of an LED display advertising sign on the top of the unit enabling the retailer to advertise “clean baskets” and other information as desired.

Advertising space if provided for displaying the retailer's logo and other information. LED or plasma signs may be used for this purpose. The retailer may marketing their brand and products in conjunction with advertizing clean and safe baskets.

Having a self-contained basket cleaning unit inside the store eliminates the need to move large batches of shopping baskets to an outside location to be cleaned; this reduces time spent by the retailer's employees.

These and other objects are attained by a shopping basket washer and sanitizer as described below and as showing in the drawings, wherein:

### BRIEF DESCRIPTION OF THE DRAWINGS

FIG. 1 is a front exterior view of an apparatus embodying the invention; and

FIG. 2 is an interior view thereof.

### DESCRIPTION OF THE PREFERRED EMBODIMENT

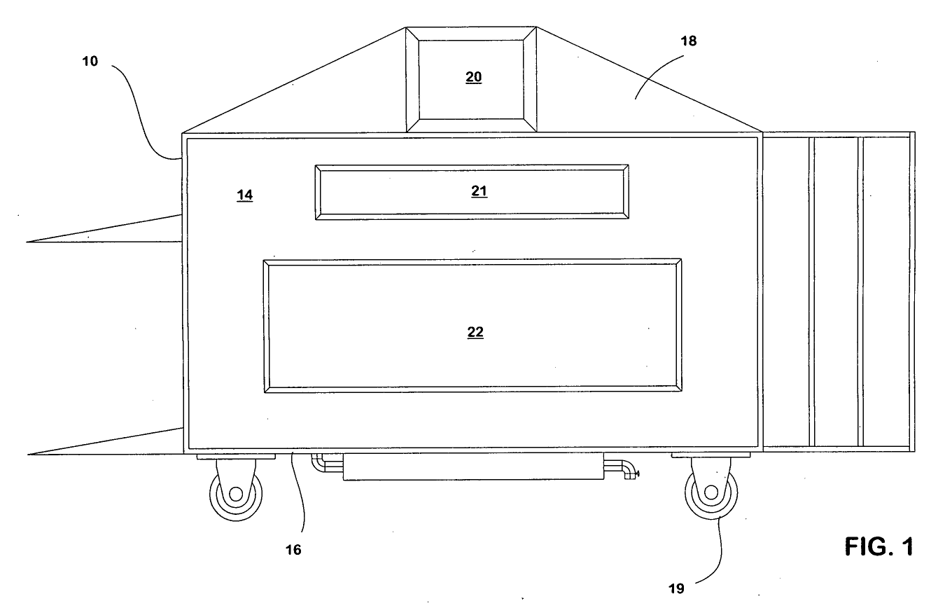

A shopping basket washer and sanitizer embodying the invention includes a cabinet 10 as shown in FIG. 1. The cabinet has an angle type rust resistant/rustproof metal (i.e. aluminum) welded frame 12 to provide maximum strength reinforcement. The cabinet is enclosed except at its two ends and it includes two walls 14, a bottom 16 and a top 18, all made of sheet metal bent in a manner to form a tunnel. The tunnel is attached to the frame using rustproof fasteners (i.e. stainless steel/aluminum) of appropriate size and length in order to create an enclosure with open ends. Locking non-marring wheels 19 are mounted at the four corners of the underside of the cabinet to provide mobility during relocation.

The cabinet has applied to its surfaces of the walls, top and floor a sound limiting material (not shown) of adequate thickness so as to limit noise emitted during operation of the unit. The top and front exterior of the cabinet is of a durable material and contains space for advertising in the form of chloroplast (or similar material) signage display and/or electrical message signs (20, 21, and 22).

The walls and other panels forming the unit are made of a material (e.g., aluminum or stainless steel) that inhibits rust formation or is rust free; joints between panels are sealed so as not to leak liquids to the outside.

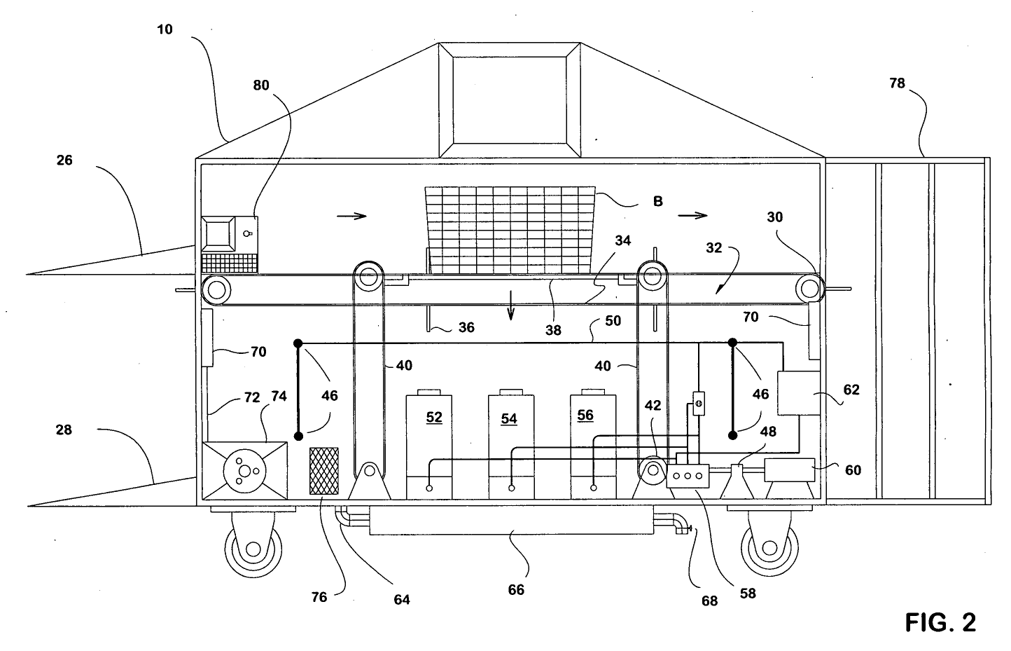

Referring now to FIG. 2, an entry ramp 26 is attached to the upper portion of the cabinet as shown and allows for the cabinet to be closed if not in use for an extended period of time. A shelf 28 below the entry ramp allows for accumulation of baskets ready to be cleaned.

At each end of the apparatus there are curtains (not shown) in the entry and exit areas to inhibit the escape of mist and overspray from the enclosure. The curtains comprise flexible PVC clear strips suspended from the top; alternatively, it could be composed of flexible groupings of “bristle” type material attached at the sides and top or other suitable material in a type, design and placement as to check the escape of mist and overspray of liquids.

The tunnel has a floor 30 which is level with the entry ramp 26. Shopping baskets “B” are pushed along the floor of the tunnel by a horizontal conveyor 32. The conveyor may be formed by a pair of chains 34 having spaced paddles or flights 36 extending transversely between the chains to engage each basket and push it along the floor of the tunnel. At least one of the chains is driven by a motor, not shown.

The horizontal conveyor carries each basket over an elevator 38, situated in a gap in the floor 32. The elevator is supported by spaced chain loops 40, at least one of which is driven intermittently by a reversible motor 42. The elevator lowers the basket into a washing chamber 44 beneath the floor 30. The basket is treated with cleaning solution (e.g., a detergent), rinsing solution (e.g., water) and a sanitizing solution while in the lowered position. Once this cycle is completed, the elevator returns the basket level of the floor, where it is re-engaged by the horizontal conveyor.

The spray nozzles 46 shown in FIG. 2 are sufficient in number and type to effectively deliver the liquids. Cleaning liquid is delivered under pressure by a pump 48 to the spray nozzles via supply lines 50 from on-board holding tanks 52, 54, 56. The liquids are routed via a multi way valve 58 located inline to the destinations. The pump is powered by a motor 60 of adequate size and type so as to provide the optimum pressure to the spray nozzles 32.

An “on demand” inline water heater 62 may be included in the system to heat some or all of the liquids to maximize the effectiveness of the cleaning process.

A floor drain at 64 directs spent liquids to a holding tank 66 for subsequent safe disposal. The holding tank is located under the cabinet complete and may have a drain cock 68 for use where the unit is not hard plumbed.

At the exit end of the cabinet, there are two air nozzles or vents 70, one on either side of the exit, extending from the level of the horizontal conveyor to the underside of the top opening. The vents are oriented so as to direct airflow back toward the interior, which tends to keep mist from escaping.

Air delivered to the vents 70 via a manifold 72 by a blower 74 which draws ambient air through a filter 62. The airflow dries the exiting units and retain overspray and mist in the tunnel. The baskets exit into a cage or rack 78 at the downstream end of the device.

An onboard computer timing device or controller 80 synchronizes the movement of the conveyor and the elevator. It also controls the cleaning cycles by operating the pump and valves to deliver cleaning agents at the appropriate times during the cleaning process. The cycle may be initiated and terminated by photosensors (not shown) at the entrance and exit of the device.

A number of controllers suitable for performing these functions are commercially available. Inasmuch as the selection, installation and programming of the controller is a matter of ordinary skill, the controller is not described herein in greater detail.

Since the invention is subject to modifications and variations, it is intended that the foregoing description and the accompanying drawings shall be interpreted as only illustrative of the invention defined by the following claims.

We claim:

1. An apparatus for washing and sanitizing shopping baskets, said apparatus comprising
a cabinet defining a tunnel having an inlet and an outlet,
means for guiding a series of shopping baskets through tunnel from the inlet to the outlet,
a spraying system for directing cleaning fluid, rinsing water and disinfectant at the shopping baskets within the apparatus; and
a drying system for removing liquid from each shopping basket before it exits the tunnel.

2. The invention of claim 1, wherein the guiding means comprises a horizontal conveyor which carries baskets from the inlet to the outlet.

3. The invention of claim 2, further comprising an elevator which intercepts baskets and lowers them from the horizontal conveyor into a washing chamber beneath the conveyor.

4. The invention of claim 3, wherein the spraying system comprises
a pump,
a motor for driving the pump,
an array of nozzles within the washing chamber, and
a system of liquid conduits for carrying liquid under pressure from the pump to the nozzles.

5. The invention of claim 4, wherein the spraying system further comprises
a plurality of tanks for containing washing liquids,
piping connecting the tanks to the pump,
a multiway valve for regulating the flow of said liquids through the piping, and
a controller for operating the multiway valve and the pump.

6. The invention of claim 1, wherein the drying system comprises
a blower,
a filter for filtering ambient air entering the blower,
at least one vent for directing drying air at carts in the tunnel, and
a manifold for carrying air from the blower to the vents.

7. The invention of claim 1, further comprising a holding tank for storing spent washing liquids.
